(19) United States
(12) Patent Application Publication
(10) Pub. No.: US 2024/0375459 A1
(43) Pub. Date: Nov. 14, 2024

(54) Method for communication between a wheel unit and a central processing unit of a motor vehicle, wheel unit for implementing said method, and wheel comprising such a wheel unit

(71) Applicant: Continental Automotive Technologies GmbH, Hannover (DE)

(72) Inventors: Jean-Philippe Boisset, Montauban (FR); Nicolas Guinart, Toulouse (FR)

(73) Assignee: Continental Automotive Technologies GmbH, Hannover (DE)

(21) Appl. No.: 18/647,219

(22) Filed: Apr. 26, 2024

(30) Foreign Application Priority Data
May 12, 2023 (FR) 2304705

(51) Int. Cl. B60C 23/04

(52) U.S. Cl. CPC B60C 23/0408

(57) ABSTRACT

A method for communication between a wheel unit and a central processing unit of a TPMS system, the wheel unit being intended for integration in a wheel of a motor vehicle. The method includes the following steps, which are aimed at: transmitting a set of transmission frames containing information relating to the wheel that is associated with the wheel unit; and sending an acknowledgement frame once the central processing unit has received a frame of the set of transmission frames transmitted by the wheel unit. The method includes a step which is aimed at interrupting the sending of a frame of said set of transmission frames transmitted by the wheel unit.

### CROSS REFERENCE TO RELATED APPLICATIONS

This application claims priority to French Application No. 2304705, filed May 12, 2023, the contents of such application being incorporated by reference herein.

### FIELD OF THE INVENTION

The present invention relates to a method for communication between a wheel unit of a tire pressure monitoring system and a central processing unit. The invention also relates to a wheel unit for implementing said communication method and to a wheel comprising such a wheel unit.

### BACKGROUND OF THE INVENTION

For safety purposes, it is known to equip a motor vehicle with a tire pressure monitoring system, which is known by the abbreviation TPMS.

Such a monitoring system generally has a central processing unit, wheel units, each of which equips an associated wheel of the vehicle, and a radiofrequency communication device suitable for ensuring communication between each wheel unit and the central processing unit.

The central processing unit has an electronic processor known by the abbreviation ECU (electronic control unit).

Each wheel unit comprises an electronic housing comprising an assembly of sensors notably designed to detect an anomaly with the wheel. These sensors may, for example, be a tire inflation pressure sensor, a temperature sensor and a wheel acceleration sensor. The electronic housing also conventionally has a means for measuring the angular position of the electronic housing.

Each wheel unit has a battery which supplies the energy needed for the transmission of messages.

The communication device makes it possible to exchange messages, or signals, between the central unit or a mobile terminal for the one part, and each wheel unit for the other part. The messages notably contain data indicative of the operating parameters of each wheel unit and an identification code for each wheel unit.

According to one embodiment known from the prior art, the electronic housings of each wheel unit transmit low-frequency signals (referred to as LF signals) to the central processing unit or a mobile terminal by virtue of a low-frequency antenna.

In order to reduce the manufacturing costs and simplify the manufacturing method, ultra-high-frequency, or UHF, radio communication, for example in accordance with the Bluetooth® standard, is also used in the field of TPMS systems.

Although the operation for transmitting low-frequency (LF) signals does not consume much power, this is not the case for ultra-high-frequency communication in accordance with the Bluetooth® standard.

However, the battery of a wheel unit has a limited service life and is not intended to be recharged.

There is therefore a recurring need in the field of communication for TPMS systems to limit the power consumption of the battery of a wheel unit.

One of the problems encountered when transmitting data between the electronic housings mounted on the wheels of motor vehicles and the central unit integrated in these motor vehicles results from the existence of zones without radiofrequency coverage, commonly referred to as “blackspots”, which consist of relative positions between the electronic housings and the central unit in which communications between them are cut off or impaired.

Since the position of these zones without coverage is very difficult to predict and to define, the current solutions implemented to alleviate the drawbacks associated with their presence are generally to multiply the number of messages transmitted.

By way of example, in the context of the transmission by the electronic housings of the signals containing data indicative of operating parameters for each wheel, the current solution is to transmit signals containing multiple identical data frames at regular time intervals over one rotation of the wheel.

Thus, in the context of the implementation of methods for locating the wheels by synchronization and angular correlation, the concept of which is based on the correlation of the angular information existing between the signals delivered by the electronic housing and signals delivered by a wheel speed sensor mounted in the vehicle in the vicinity of each wheel, the solution implemented for avoiding a loss of information in the event of transmissions across the blackspots consists in commanding each electronic housing to transmit multiple signals, referred to as synchronized signals, which are sent at successive instants for different angular positions of the electronic housing.

Consequently, in order to statistically ensure the performance of radiofrequency transmissions, the current solutions are to multiply the number of messages transmitted by the electronic housings of the wheel units by varying either a repetition of the number of frames transmitted during each transmission, or a distribution of the synchronized transmissions over multiple angles.

The multiplication of the number of messages transmitted by the electronic housings greatly reduces the service life of the battery of a wheel unit.

### SUMMARY OF THE INVENTION

An aspect of the present invention is aimed at overcoming the drawbacks of the prior art, and to this end relates to a method for communication between at least one wheel unit of a tire pressure monitoring system and a central processing unit of said monitoring system, said at least one wheel unit being intended for integration in at least one wheel of a motor vehicle and comprising:
an electronic housing, comprising an assembly of sensors designed to detect an anomaly with said at least one wheel and a means for measuring the angular position of said electronic housing,
a battery supplying the power needed for communication between said at least one wheel unit and said central processing unit, said method comprising the following steps, which are aimed at:
transmitting, from said at least one wheel unit, a set of transmission frames containing information relating to said at least one wheel that is associated with said at least one wheel unit,
sending, from said central processing unit, an acknowledgement frame once said central processing unit has received at least one frame of said set of transmission frames transmitted by said at least one wheel unit,
   said method being notable in that it comprises, after said step which is aimed at sending said acknowledgement frame, a step which is aimed at interrupting the sending of at least one frame of said set of transmission frames transmitted by said at least one wheel unit.

Thus, providing the interruption of the sending of frames after the step of sending an acknowledgement frame means that the wheel units of the TPMS system do not continue to transmit when the central processing unit has received the expected information.

This limits the number of exchanges between the electronic housings of the wheel units and the central unit of the motor vehicle.

By optimizing the exchanges in this way, the power consumption of the batteries of the wheel units is optimized.

As a result, the service life of the batteries of such wheel units is increased in relation to the prior art, in spite of the use of ultra-high-frequency radio wave communication in accordance with the Bluetooth® standard and still without needing a communication mode with low-frequency (LF) signal transmission, in which communication mode the architecture is more expensive and more complex than that deployed for communicating in accordance with the Bluetooth® standard.

According to optional features of the communication method according to an aspect of the invention:
said interrupting step is implemented once said acknowledgement frame, which informs that said transmission frame was indeed received, has been sent during said sending step;
according to one embodiment, said transmitting step is implemented by transmitting said set of transmission frames at predetermined transmission angles and the motor vehicle has an assembly of wheel speed sensors, said method including an additional step, after said sending step and prior to said interrupting step, which is aimed at qualifying, from among said set of transmission frames transmitted during said transmitting step, those that have a satisfactory reception power and those that have an unsatisfactory reception power;
said interrupting step consists in interrupting the sending of transmission frames qualified during said qualifying step as having an unsatisfactory reception power;
in one embodiment, said satisfactory reception power takes a range of values between 0 dBm and −80 dBm, in particular between −40 dBm and −50 dBm;
in one embodiment, said unsatisfactory reception power takes a range of values below −80 dBm, in particular between −90 dBm and −100 dBm;
according to one embodiment, said transmitting step is implemented by transmitting said set of transmission frames on transmission channels and said method includes an additional step, after said sending step and prior to said interrupting step, which is aimed at eliminating, from among said set of transmission frames transmitted during said transmitting step, the ineffective transmission channels on which an acknowledgement frame was not transmitted during said sending step;
said interrupting step consists in interrupting the sending of transmission frames on said ineffective transmission channels that were eliminated during said eliminating step;
in one embodiment, a pair of data combining an optimum transmission angle and an optimum transmission channel is determined;
said qualifying step and/or said eliminating step is/are carried out by implementing a learning phase;
according to one embodiment, said method includes a step, prior to said transmitting step, in which said at least one wheel unit sends, to said central processing unit, a preliminary message indicating a transmission date and a transmission channel that are envisaged for the transmission of a first transmission frame of said set of transmission frames.

An aspect of the invention also relates to a wheel unit for a tire pressure monitoring system, the wheel unit being intended for integration in a wheel of a motor vehicle and having hardware and/or software means for implementing the method according to an aspect of the invention.

An aspect of the invention also relates to a wheel for a motor vehicle comprising at least one wheel unit for a tire pressure monitoring system, the wheel being notable in that said wheel unit is in accordance with an aspect of the invention.

### BRIEF DESCRIPTION OF THE DRAWINGS

Other features, aims and advantages of aspects of the invention will become apparent from reading the following detailed description, for the understanding of which reference will be made to the appended drawings, in which:

FIG. 1 is a schematic view of a motor vehicle according to an aspect of the invention.

FIG. 2 shows in detail the steps of the communication method according to an aspect of the invention.

FIG. 3 illustrates the steps for implementing the communication method according to a first embodiment.

FIG. 4 illustrates the steps for implementing the communication method according to a second embodiment.

FIG. 5 shows the steps for implementing the communication method according to an embodiment variant.

FIG. 6 shows an exemplary embodiment of the method according to the embodiment variant in FIG. 5.

### DETAILED DESCRIPTION OF THE PREFERRED EMBODIMENTS

In the rest of the description, elements that have an identical structure or similar functions are denoted by one and the same reference.

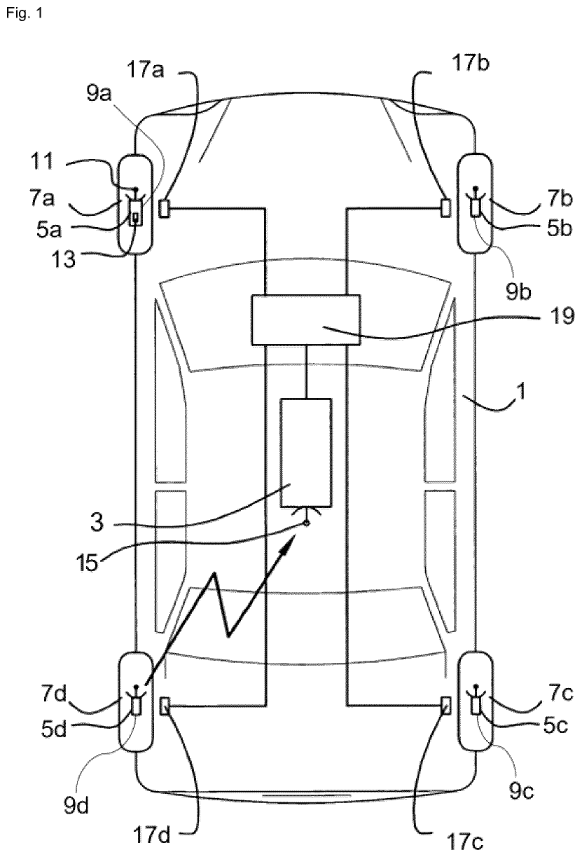

Reference is made to FIG. 1, which illustrates a motor vehicle 1 equipped with a tire pressure monitoring system, which is known by the abbreviation TPMS.

The TPMS system has a central processing unit 3 comprising an electronic processor, which is known by the abbreviation ECU (electronic control unit) and four wheel units 5a, 5b, 50, 5d which are each mounted on an associated wheel 7a, 7b, 7c, 7d.

Each wheel unit 5a, 5b, 5c, 5d comprises a battery which supplies the power needed for communication between the wheel unit 5a, 5b, 50, 5d and the central processing unit 3.

Each wheel unit 5a, 5b, 5c, 5d also comprises an electronic housing 9a, 9b, 9c, 9d, comprising a set of sensors and for example secured to the rim or to the inflation valve of the wheel 7a, 7b, 7c, 7d so as to be positioned inside the tire casing, or alternatively on the internal face of the tire tread.

Each of the electronic housings 9a, 9b, 9c, 9d is designed to detect an anomaly with the wheel 7a, 7b, 7c, 7d.

To that end, each of the electronic housings 9a, 9b, 9c, 9d has integrated sensors which are dedicated to measuring tire parameters and are connected to a microprocessor processing unit connected to a transmitter 11.

Each of the electronic housings 9a, 9b, 9c, 9d also conventionally has an integrated measuring means 13 for measuring the angular position of the electronic housing 9a, 9b, 9c, 9d.

Such measuring means may advantageously consist of an accelerometer capable of supplying modulated signals that are indicative of the values of gravity, and therefore of the angular position of the electronic housing 9a, 9b, 9c, 9d, and have a frequency, equal to the frequency of rotation of the wheels 7a, 7b, 7c, 7d, that also makes it possible to calculate the rotational speed of the wheels 7a, 7b, 7c, 7d.

Furthermore, the central unit 3 of the TPMS system comprises a microprocessor and a communication device 15 capable of receiving the signals transmitted by the transmitters 11 of each of the four electronic housings 9a, 9b, 9c, 9d.

For this, the communication device 15 has a transceiver which makes it possible to exchange messages, or signals, bidirectionally between the central unit 3 and each wheel unit 5a, 5b, 5c, 5d.

The messages exchanged between the central unit 3 and each wheel unit 5a, 5b, 5c, 5d notably include data indicative of operating parameters for each wheel 7a, 7b, 7c, 7d.

The communication is done in accordance with a communication protocol for the short-range bidirectional exchange of data using ultra-high-frequency, or “UHF”, radio waves, for example in accordance with the Bluetooth® standard.

The motor vehicle 1 is also equipped with an active safety system such as an “ABS” anti-lock braking system, or an “ESP” dynamic electronic stability system, comprising four wheel speed sensors 17a, 17b, 17c, 17d positioned on the motor vehicle 1, each in the vicinity of the wheels 7a, 7b, 7c, 7d, and designed to supply, in the form of values that can be converted into angular values, data indicative of the orientation of the wheel 7a, 7b, 7c, 7d.

This active safety system comprises an “ABS” or “ESP” processor 19 which is connected to the various wheel speed sensors 17a, 17b, 17c, 17d so as to receive the wheel speed information measured by said sensors and is programmed to anticipate the control needed in order to prevent the wheels 7a, 7b, 7c, 7d from locking.

The wheel speed sensors 17a, 17b, 17c, 17d usually consist of inductive, magneto-resistive or Hall-effect sensors designed to measure the angular speed of each wheel 7a, 7b, 7c, 7d on a toothed or magnetic wheel.

Such equipment notably makes it possible, first of all, to locate the wheels 7a, 7b, 7c, 7d by using a method of synchronization and angular correlation based on the existing correlation between the signals delivered by the speed sensor 13 with which each wheel 7a, 7b, 7c, 7d is equipped and synchronized signals delivered by the wheel speed sensor 17a, 17b, 17c, 17d mounted on the motor vehicle 1 in the vicinity of each wheel 7a, 7b, 7c, 7d.

Such equipment notably makes it possible, after that, to transmit signals containing data indicative of operating parameters for each wheel 7a, 7b, 7c, 7d and an identification code for the electronic housing 9a, 9b, 9c, 9d mounted on said wheel.

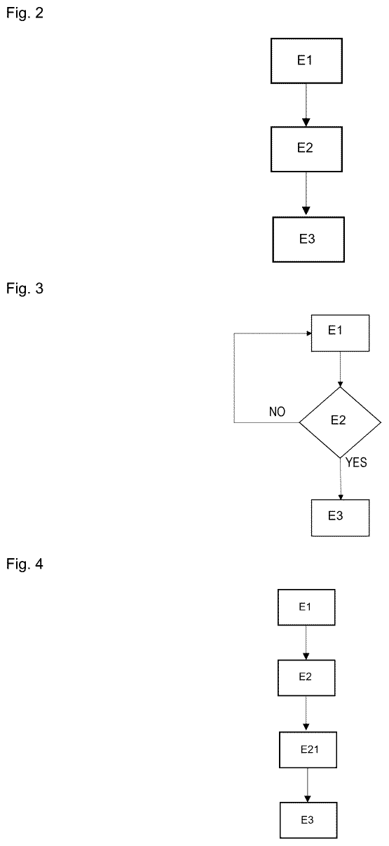

Reference is made to FIG. 2 for illustration of the steps of the communication method according to an aspect of the invention.

The aim of the communication method according to an aspect of the invention is to optimize the communication between at least one of the wheel units 5a, 5b, 5c, 5d of the TPMS system and the central processing unit 3, by limiting the power consumption of the battery that supplies the power needed for communication between the wheel unit 5a, 5b, 5c, 5d and the central processing unit 3.

For this, the communication method includes a first step (step E1) which is aimed at transmitting, from at least one of the wheel units 5a, 5b, 50, 5d, a set of transmission frames containing information relating to the wheel 7a, 7b, 7c, 7d that is associated with the wheel unit 5a, 5b, 5c, 5d, for example information from the TPMS system that contains the pressure and temperature values of the tire that is associated with the wheel unit 5a, 5b, 5c, 5d.

The communication method includes a second step (step E2) which is aimed at sending, from the central processing unit 3, an acknowledgement frame when the central processing unit 3 has received at least one frame of the set of transmission frames transmitted by the wheel unit 5a, 5b, 5c, 5d during step E1.

As is known, the acknowledgement frame contains a set of information. Natively in accordance with the Bluetooth® standard, when a transmitter transmits a frame, the receiver can indicate to the transmitter that it has indeed received the frame sent. For this, the transmitter transmits a frame referred to as “scan request”. The receiver triggers the sending of a frame referred to as “scan response”, which comprises a set of additional information. An acknowledgement message indicating that the frame sent has indeed been received is then also transmitted. As is known, the reception of an acknowledgement message can cause a set of steps that are not part of the invention to be triggered.

According to an aspect of the invention, the communication method includes a step E3 which is aimed at interrupting, after step E2 which is aimed at sending the acknowledgement frame, the sending of at least one frame of the set of transmission frames transmitted by the wheel unit 5a, 5b, 5c, 5d during step E1.

Thus, providing for the interruption of the sending of a frame of the set of transmission frames transmitted by the wheel unit 5a, 5b, 5c, 5d during step E1 after the transmission of an acknowledgement frame, means that the number of times sent frames are transmitted when an acknowledgement frame informing that the transmission frame was indeed received has been transmitted is limited.

The number of messages transmitted by the electronic housings of the TPMS system is consequently reduced, thereby making it possible to greatly increase the service life of the battery of the wheel unit 5a, 5b, 5c, 5d.

Reference is made to FIG. 3 for the detailed description of a first embodiment of the communication method according to the invention.

The communication method according to an aspect of the invention can be implemented in order to interrupt the sending of transmission frames once an acknowledgement frame is transmitted by the central processing unit 3.

To do this, step E3, which is aimed at interrupting the sending of a frame of the set of transmission frames transmitted by the wheel unit 5a, 5b, 5c, 5d during step E1 after the transmission of an acknowledgement frame, is implemented once an acknowledgement frame informing that the transmission frame was indeed received has been sent during step E2.

As a result, when the motor vehicle is in a running mode referred to as “normal”, the electronic housing 9a, 9b, 9c, 9d of one of the wheel units 5a, 5b, 5c, 5d transmits a set of transmission frames containing information relating to the wheel 7a, 7b, 7c, 7d that is associated with the wheel unit 5a, 5b, 50, 5d (step E1 of the communication method according to an aspect of the invention).

The transmission frames are, for example, transmitted at a predetermined temporal frequency, for example every 16 seconds or every 32 seconds or every 64 seconds.

More particularly, the algorithm implementing the communication method is parametrized to transmit these frames at a predetermined temporal frequency and multiple times during a rotation of the wheel 7a, 7b, 7c, 7d, with the aim of increasing the probability of the central processing unit 3 receiving the frames transmitted by the wheel unit 5a, 5b, 5c, 5d.

For example, the algorithm implementing the communication method is parametrized to transmit transmission frames at angles that are equidistant during the revolution of the wheel, in order to limit the risk of the central unit 3 not receiving them. For example, the transmission frames are transmitted three times per revolution of the wheel when an acknowledgement frame is not being transmitted by the central processing unit 3.

According to an aspect of the invention, once an acknowledgement frame informing that the transmission frame was indeed received has been sent during step E2, step E3 of the communication method interrupts the sending of subsequent frames.

For example, if, during a rotation of the wheel 7a, 7b, 7c, 7d, the first transmission frame of the set of three transmission frames transmitted by the wheel unit 5a, 5b, 5c, 5d is not received by the central processing unit 3 owing to the existence of a zone without radiofrequency cover (“blackspot”), an acknowledgement frame is not sent.

The wheel 7a, 7b, 70, 7d continues to rotate. A second transmission frame of the set of three transmission frames is then transmitted by the wheel unit 5a, 5b, 5c, 5d.

If the second transmission frame is received by the central processing unit 3, an acknowledgement frame is sent, in accordance with step E2 of the communication method of an aspect of the invention.

Step E3, which is aimed at interrupting the sending of a frame of the set of transmission frames transmitted by the wheel unit 5a, 5b, 5c, 5d during step E1, is then initiated. The wheel 7a, 7b, 7c, 7d continues to rotate and, in accordance with step E3 of the communication method, no more transmission frames are transmitted over the continued rotation of the wheel 7a, 7b, 7c, 7d.

As a result, in the example which has just been mentioned, the third transmission frame initially intended for the transmission frequency in question by the algorithm for implementing the method is not sent.

The transmission of frames once the transmitted frame has effectively been received is thus avoided, thereby very advantageously making it possible to limit the power consumption of the batteries of the wheel units 5a, 5b, 5c, 5d.

The reception of the acknowledgement message is thus used to deduce that the central processing unit 3 has indeed received the information transmitted by the wheel unit 5a, 5b, 5c, 5d and to command the interruption of the transmission of transmission frames by the wheel unit 5a, 5b, 5c, 5d.

Reference is made to FIG. 4 for the detailed description of a second embodiment of the communication method according to the invention.

In this embodiment, the communication method according to an aspect of the invention is implemented within the framework of a running mode referred to as “locating mode”, used to locate the wheels and correspondingly associate the wheel units.

This functionality is typically used to detect a problem on one of the wheels of the motor vehicle and to identify which of these wheels exhibits this anomaly.

For example, this functionality makes it possible to detect a pressure drop owing to a slow puncture and to identify which wheel is subject to this pressure drop.

To do this, a known method consists in correlating angular information between the signals delivered by the electronic housings 9a, 9b, 9c, 9d of the wheel units 5a, 5b, 5c, 5d and the signals delivered by the wheel speed sensors 17a, 17b, 17c, 17d.

This correlation method can be implemented by virtue of a function referred to as “LSE”, which is an abbreviation for localization synchronized emission.

This function is shared between the wheel units 5a, 5b, 50, 5d and the central processing unit 3 of the motor vehicle 1.

In order to perform this function, each wheel unit 5a, 5b, 5c, 5d is parametrized to transmit a first transmission frame at a known angle of rotation of the wheel 7a, 7b, 7c, 7d, for example at 0°.

The other frames are, for example, transmitted at angles that are equidistant during the revolution of the wheel. For example, four frames are transmitted for one revolution of the wheel. The four frames are thus respectively transmitted when the rotation of the wheel is 0°, then 90°, then 180°, and then 270°.

For each of the wheels 7a, 7b, 7c, 7d of the motor vehicle 1, the central processing unit 3 compares the transmission angles of the wheel units 5a, 5b, 5c, 5d, which for their part are known and fixed, with the reception angles of the wheel speed sensors 17a, 17b, 17c, 17d.

On the basis of this information, a table is constructed and the central processing unit 3 indicates a pairing between one of the wheel units 5a, 5b, 5c, 5d and one of the wheel speed sensors 17a, 17b, 17c, 17d when, for a given wheel unit 5a, 5b, 5c, 5d, the information transmitted by the transmission frame for a known transmission angle is always received at the same angle according to one of the wheel speed sensors 17a, 17b, 17c, 17d.

However, the central processing unit 3 indicates a lack of pairing between one of the wheel units 5a, 5b, 5c, 5d and one of the wheel speed sensors 17a, 17b, 17c, 17d when, for a given wheel unit 5a, 5b, 5c, 5d, the information transmitted by the transmission frame for a known transmission angle is not always received at the same reception angle according to the wheel speed sensors 17a, 17b, 17c, 17d. The central processing unit 3 then understands that the wheel speed sensor 17a, 17b, 17c, 17d does not correspond to this wheel unit 5a, 5b, 5c, 5d.

In this embodiment, step E1 of the communication method is implemented by transmitting, for each of the wheels 7a, 7b, 7c, 7d of the motor vehicle 1, transmission frames at predetermined wheel-revolution transmission angles.

In accordance with step E2 of the communication method, an acknowledgement frame is sent when the central processing unit 3 has received at least one of the frames transmitted during step E1.

In this embodiment, the communication method includes an additional step E21, after step E2 of sending an acknowledgement frame and prior to step E3 of interrupting the sending of a frame of the set of transmission frames.

The additional step E21 is aimed at qualifying, from among the transmission frames sent during step E1 and for which an acknowledgement frame has been sent, those that have a satisfactory reception power and those that have an unsatisfactory reception power.

The information relating to the reception power can, for example, be measured by the wheel unit 5a, 5b, 5c, 5d of the TPMS system receiving the “scan request” frame.

The information relating to the reception power is thus included in the additional information sent by the central processing unit 3 when said central processing unit 3 transmits an acknowledgement frame.

For example, in the context of an aspect of the present invention, a reception power of between 0 dBm and −80 dBm is considered to be satisfactory. More specifically, a reception power of between −40 dBm and −50 dBm is considered to be satisfactory.

Conversely, in the context of an aspect of the present invention, a reception power of below −80 dBm is considered to be unsatisfactory. More specifically, a reception power of between −90 dBm and −100 dBm is considered to be unsatisfactory.

Step E3 of the communication method, which is aimed at interrupting the sending of a frame of the set of transmission frames transmitted by the wheel unit 5a, 5b, 5c, 5d during step E1 after the transmission of an acknowledgement frame, consists in this embodiment in interrupting the sending of transmission frames that have been qualified, during step E21, as having an unsatisfactory reception power.

For the exemplary embodiment given above, the communication method works as follows.

The wheel units 5a, 5b, 5c, 5d transmit (step E1) transmission frames when the angle of rotation of the corresponding wheels 7a, 7b, 7c, 7d is equal to 0°, then to 90°, then to 180°, and then to 270°.

An acknowledgement frame is sent (step E2) for the transmission frames received by the central processing unit 3.

For each of the transmission frames that has resulted in acknowledgement frames being sent, those that have a satisfactory reception power and those that have an unsatisfactory reception power are qualified (step E21).

The sending of transmission frames that were qualified during step E21 as having an unsatisfactory reception power is interrupted (step E3).

In one embodiment of the invention, step E21 can be carried out by implementing a learning phase.

The learning phase can be implemented for a predetermined period of time that may correspond to a predetermined number of revolutions of the wheel 7a, 7b, 7c, 7d.

In one embodiment, the learning phase is implemented over 5, 10 or 15 revolutions of the wheel 7a, 7b, 7c, 7d.

In one embodiment, the learning phase can be initiated each time the motor vehicle 1 is driven or at the end of a certain number of predetermined times that the motor vehicle is driven.

During the implementation of the learning phase, the communication method carries out step E1 of sending transmission frames, step E2 of sending acknowledgement frames and step E21 of qualifying the reception powers throughout the duration of the learning phase, without carrying out interrupting step E3.

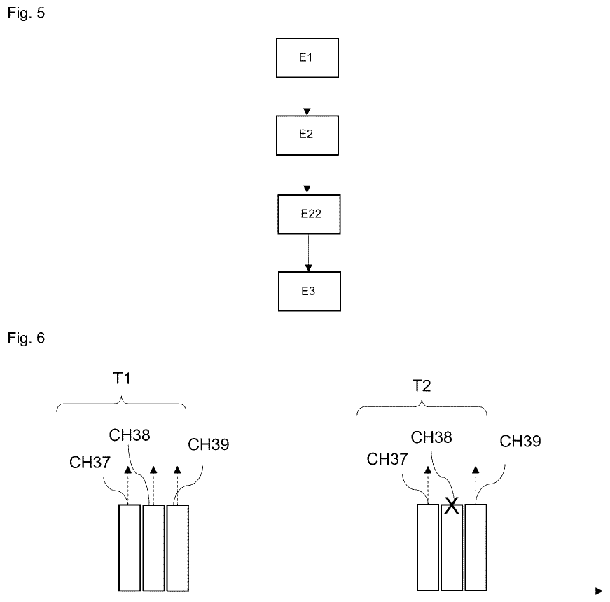

Reference is made to FIG. 5 for the detailed description of an embodiment variant of the communication method according to an aspect of the invention.

In accordance with the current Bluetooth® standard, each transmission frame has three transmission channels CH37, CH38, CH39, which transmit at the frequencies 2402 MHZ, 2426 MHz and 2480 MHz, respectively.

Step E1 of sending transmission frames is carried out periodically on multiple transmission frames which follow one another in time.

In this embodiment, step E1 of the communication method is implemented by transmitting, for each of the wheels 7a, 7b, 7c, 7d of the motor vehicle 1, transmission frames on each of the transmission channels CH37, CH38, CH39 of a transmission frame.

In accordance with step E2 of the communication method, an acknowledgement frame is sent when the central processing unit 3 has received at least one of the transmission frames transmitted during step E1.

This embodiment also includes an additional step E22 of eliminating transmission channels that are considered to be “ineffective” transmission channels.

The additional step E22 comes after step E2 of sending an acknowledgement frame and prior to step E3 of interrupting the sending of a frame of the set of transmission frames.

The additional step E22 is aimed at eliminating, from among the transmission frames sent during step E1 and on the basis of step E2 of sending acknowledgement frames, for which ones of the transmission channels from among the channels CH37, CH38, CH39 an acknowledgement frame was not transmitted during step E2.

Step E3 of the communication method, which is aimed at interrupting the sending of a frame of the set of transmission frames transmitted by the wheel unit 5a, 5b, 5c, 5d during step E1 after the transmission of an acknowledgement frame, thus consists in this embodiment in interrupting the sending of transmission frames on the channels that were eliminated during step E22.

Reference is made to FIG. 6, which illustrates an exemplary embodiment of the method according to the invention according to the embodiment variant of FIG. 5.

In FIG. 6, two successive transmission frames T1 and T2 are sent by the wheel unit 5a, 5b, 5c, 5d.

Step E1 of sending transmission frames is carried out on a first transmission frame T₁ and on a second transmission frame T₂, which comes after the transmission frame T₁ in time.

When the channels CH37, CH38, CH39 of the transmission frame T₁ have stopped transmitting, the central processing unit 3 sends an acknowledgement frame for each transmission frame effectively received (step E2).

In the example illustrated in FIG. 6, the central processing unit 3 is considered to have sent acknowledgement frames for the transmission frames sent on the channels CH37 and CH39.

Step E22 of eliminating transmission channels considered to be “ineffective” channels thus in this case eliminates channel CH38, for which an acknowledgement frame was not sent by the central processing unit 3 during step E2.

When the eliminating step E22 has eliminated the channel CH38, which was considered to be an ineffective channel, step E3 interrupts the sending of frames on the channel CH38.

Thus, for frame T2, transmission frames are transmitted solely on the channels CH37 and CH39.

The interruption of sending transmission frames eliminated during step E22 can be applied over a predetermined period of time which can, for example, correspond to a predetermined number of revolutions of the wheel.

The embodiment variant of the communication method which has just been described with reference to FIGS. 5 and 6 applies both to the first embodiment described with reference to FIG. 3 and to the second embodiment described with reference to FIG. 4.

When the embodiment variant of the communication method is applied to the second embodiment described with reference to FIG. 4, by virtue of the implementation of steps E21 and E22 a pair of data combining an optimum transmission angle with an optimum transmission channel is determined, making it possible to optimize the transmission of transmission frames both in terms of the transmission angle and the transmission channel.

Step E21 and step E22 can be implemented simultaneously or in succession in relation to one another.

In one embodiment of the invention, step E22 can be carried out by implementing a learning phase which, like for step E21, which was described with reference to the preceding embodiment, can be implemented over a predetermined period of time that can correspond to a predetermined number of revolutions of the wheel 7a, 7b, 7c, 7d.

In one embodiment, the learning phase is implemented over 5, 10 or 15 revolutions of the wheel 7a, 7b, 7c, 7d.

In one embodiment, the learning phase can be initiated each time the motor vehicle 1 is driven or at the end of a certain number of predetermined times that the motor vehicle is driven.

According to one embodiment variant of the communication method shared by all of the embodiments that have just been described, the communication method includes a step E0, prior to step E1 of transmitting transmission frames, in which the wheel unit 5a, 5b, 5c, 5d sends, to the central processing unit 3, a preliminary message indicating the transmission date and the transmission channel that are envisaged for the transmission of the first transmission frame of the set of transmission frames.

The wheel unit 5a, 5b, 5c, 5d comprises hardware and/or software means for implementing the method to which an aspect of the invention relates. The software means can notably comprise computer program code means which notably comprises the algorithm described in detail above and is designed to perform the steps of the method according to an aspect of the invention.

The method according to an aspect of the invention has been described with reference to communication between the wheel units 5a, 5b, 5c, 5d of the TPMS system for the one part, and the central processing unit 3 for the other part.

However, the method according to an aspect of the invention also applies for establishing communication between the wheel units for the one part, and a mobile terminal for the other part.

It goes without saying that aspects of the present invention are not limited to just those embodiments of this communication method, of this wheel unit for implementing said method, and of the wheel comprising such a wheel unit that were described above solely by way of illustrative example, but rather encompasses all the variants involving technical equivalents of the means described and their combinations, provided they fall within the scope of the invention.

1. A method for communication between at least one wheel unit of a tire pressure monitoring system and a central processing unit of said monitoring system, said at least one wheel unit being intended for integration in at least one wheel of a motor vehicle and comprising:
an electronic housing, comprising an assembly of sensors designed to detect an anomaly with said at least one wheel and a means for measuring the angular position of said electronic housing,
a battery supplying the power needed for communication between said at least one wheel unit and said central processing unit,
at the method comprising:
transmitting, from said at least one wheel unit, a set of transmission frames containing information relating to said at least one wheel that is associated with said at least one wheel unit,
sending, from said central processing unit, an acknowledgement frame once said central processing unit has received at least one frame of said set of transmission frames transmitted by said at least one wheel unit,
after said step which is aimed at sending said acknowledgement frame, a step which is aimed at interrupting the sending of at least one frame of said set of transmission frames transmitted by said at least one wheel unit.

2. The communication method as claimed in claim 1, wherein said interrupting step is implemented once said acknowledgement frame, which informs that said transmission frame was indeed received, has been sent during said sending step.

3. The communication method as claimed in claim 1, wherein said transmitting step is implemented by transmitting said set of transmission frames at predetermined transmission angles, and wherein said motor vehicle has an assembly of wheel speed sensors, and further comprising an additional step, after said sending step and prior to said interrupting step, which is aimed at qualifying, from among said set of transmission frames transmitted during said transmitting step, those that have a satisfactory reception power and those that have an unsatisfactory reception power.

4. The communication method as claimed in claim 3, wherein said interrupting step consists in interrupting the sending of transmission frames qualified during said qualifying step as having an unsatisfactory reception power.

5. The communication method as claimed in claim 3, wherein said satisfactory reception power takes a range of values between 0 dBm and −80 dBm, in particular between −40 dBm and −50 dBm.

6. The communication method as claimed in claim 3, wherein said unsatisfactory reception power takes a range of values below −80 dBm, in particular between −90 dBm and −100 dBm.

7. The communication method as claimed in claim 3, wherein said transmitting step is implemented by transmitting said set of transmission frames on transmission channels, wherein that it includes an additional step, after said sending step and prior to said interrupting step, which is aimed at eliminating, from among said set of transmission frames transmitted during said transmitting step, the ineffective transmission channels on which an acknowledgement frame was not transmitted during said sending step.

8. The communication method as claimed in claim 7, wherein said interrupting step consists in interrupting the sending of transmission frames on said ineffective transmission channels that were eliminated during said eliminating step.

9. The communication method as claimed in claim 7, wherein a pair of data combining an optimum transmission angle and an optimum transmission channel is determined.

10. The communication method as claimed in claim 3, wherein said qualifying step and/or said eliminating step is/are carried out by implementing a learning phase.

11. The communication method as claimed in claim 1, further comprising a step E0, prior to said transmitting step, in which said at least one wheel unit sends, to said central processing unit, a preliminary message indicating a transmission date and a transmission channel that are envisaged for the transmission of a first transmission frame of said set of transmission frames.

12. A wheel unit for a tire pressure monitoring system, the wheel unit being intended for integration in a wheel of a motor vehicle and having hardware and/or software means for implementing the method as claimed in claim 1.

13. A wheel for a motor vehicle comprising at least one wheel unit for a tire pressure monitoring system, wherein said wheel unit is as claimed in claim 12.

14. The communication method as claimed in claim 4, wherein said satisfactory reception power takes a range of values between 0 dBm and −80 dBm, in particular between −40 dBm and −50 dBm.

15. The communication method as claimed in claim 8, wherein a pair of data combining an optimum transmission angle and an optimum transmission channel is determined.
